(19) United States
(12) Patent Application Publication
(10) Pub. No.: US 2010/0118740 A1
(43) Pub. Date: May 13, 2010

(54) SYSTEM AND METHOD FOR IDENTIFYING NON-MULTIPLE SPANNING TREE PROTOCOL CONTROL PLANES

(76) Inventors: Attila Takács, Budapest (HU); Panagiotis Saltsidis, Stockholm (SE)

Correspondence Address: ERICSSON INC., 6300 LEGACY DRIVE, M/S EVR 1-C-11, PLANO, TX, 75024, US

(21) Appl. No.: 12/596,667

(22) PCT Filed: Apr. 16, 2008
(86) PCT No.: PCT/IB08/00929

§ 371 Date: Oct. 19, 2009

Related U.S. Application Data
(60) Provisional application No. 60/912,763, filed on Apr. 19, 2007.

(51) Int. Cl. H04L 12/28

(52) U.S. Cl. 370/256

(57) ABSTRACT

A system, method, and node for identifying non-Multiple Spanning Tree Protocol control planes. The method includes the steps of identifying a specific non-Multiple Spanning Tree Protocol control plane instance, associating a General Control Plane Identification, GCPID, with the specific control plane instance, wherein the GCPID binds a Virtual Local Area Identifier, VID, with the specific control plane, and advertising the GCPID to identify the specific control plane instance.

### CROSS-REFERENCE TO RELATED APPLICATIONS

This application claims the benefit of U.S. Provisional Application No. 60/912,763, filed Apr. 19, 2007, the disclosure of which is incorporated herein by reference.

### TECHNICAL FIELD

The present invention relates to computer networks. More particularly, and not by way of limitation, the present invention is directed to a system and method for identifying non-Multiple Spanning Tree Protocol control planes.

### BACKGROUND

The IEEE Std. 802.1Q provides a standard for local and metropolitan area networks for virtual bridged local area networks (LANs). In particular, the standard provides a specification standard for a Spanning Tree Protocol that is specifically designed for use with networks that support virtual LANs (VLANs). The Multiple Spanning Tree Protocol (MSTP) organizes a bridged network into a plurality of regions. Within each region, MSTP establishes an Internal Spanning Tree (IST) which provides connectivity to all bridges within the respective region and to the ISTs established within other regions. The IST established within each MSTP Region also provides connectivity to one Common Spanning Tree (CST) established outside of the MSTP regions compatible bridges running rapid spanning tree protocol (RSTP) or spanning tree protocol (STP). The IST of a given MST Region receives and sends bridge protocol data units (BPDUs) to the CST. Accordingly, all bridges of the bridged network are connected by a single Common and Internal Spanning Tree (CIST). Essentially, each MST Region appears as a single virtual bridge on the CST.

Within each MST Region, the MSTP compatible bridges establish a plurality of active topologies, each of which is called a Multiple Spanning Tree Instance (MSTI). The MSTP bridges also assign or map each VLAN to one and only one of the MSTIs. Because VLANs may be assigned to different MSTIs, frames associated with different VLANs can take different paths through an MSTP Region. The bridges may, but typically do not, compute a separate topology for every single VLAN, thereby conserving processor and memory resources. Each MSTI is essentially a simple RSTP instance that exists only inside the respective Region. In addition, the MSTIs do not interact outside of the Region.

MSTP provides system and method to use multiple spanning trees. Virtually all these trees (data plane forwarding topologies) are managed by independent (control plane) MSTIs, each of which is identified by a distinct Multiple Spanning Tree Identifier (MSTID). The VLAN space is organized into specific, unambiguous control plane instances. Specifically, each VLAN identifier (VID) is assigned to at most one MSTID. In addition, Filtering Databases (FDBs) are assigned to spanning tree instances through a filtering identifier (FID) to a MSTI Allocation Table as described in IEEE Std. 802.1Q/8.9.3. VIDs are also assigned to FIDs statically or more dynamically based on VLAN Learning Constraints as described in IEEE Std. 802.1Q/8.8.7. As a result, the MST Configuration Table (see IEEE Std. 802.1Q/8.9.1) is calculated based on the above information that contains the actual VID to MSTI mappings.

IEEE is working on Provider Backbone Bridging Traffic Engineering (PBB-TE) that will open up the Ethernet standard to allow non-MSTP control mechanisms. One option to realize this extension is the reservation of a special MSTID. VLANs assigned to this MSTID will be out of the control of the MSTP.

To control Ethernet forwarding, Provider Backbone Transport (PBT) promotes the static configuration of end-to-end paths in the network. In parallel extensions to the Generalized Multi-Protocol Label Switching (GMPLS) control plane for Ethernet are standardized in IETF.

PBB-TE allows for non-MSTP control planes. However, only a single MSTID will be allocated for non-MSTP control planes. VIDs assigned to new control planes will be mapped to the very same special MSTID. Currently, no further mapping is possible between the non-MSTP control planes and the VIDs.

### SUMMARY

The present invention differentiates various non-MSTP control planes in a network. The present invention provides a system, method, and node for identifying non-Multiple Spanning Tree Protocol control planes.

Thus, in one aspect, the present invention is directed to a method that includes the steps of identifying a specific non-Multiple Spanning Tree Protocol control plane instance, associating a General Control Plane Identification, GCPID, with the specific control plane instance, wherein the GCPID binds a Virtual Local Area Identifier, VID, with the specific control plane, and advertising the GCPID to identify the specific control plane instance.

In another aspect, the present invention is directed to a system for identifying non-Multiple Spanning Tree Protocol control planes. The system includes a network node which identifies a specific non-Multiple Spanning Tree Protocol control plane instance and associates a GCPID with the specific control plane instance. The GCPID binds a VID with the specific control plane. The node also advertises the GCPID to identify the specific control plane instance.

In yet another aspect, the present invention is directed to a node for identifying non-Multiple Spanning Tree Protocol control planes. The node is capable of identifying a specific non-Multiple Spanning Tree Protocol control plane instance and associating a GCPID, with the specific control plane instance. The GCPID binds a VID with the specific control plane. The node also is capable of advertising the GCPID to identify the specific control plane instance.

### BRIEF DESCRIPTION OF THE DRAWINGS

In the following section, the invention will be described with reference to exemplary embodiments illustrated in the figures, in which:

FIG. 1 illustrates a simplified block diagram of a node for verifying VID to MSTID and GCPID assignments in the preferred embodiment of the present invention;

FIG. 2 is a flow chart illustrating the steps of verifying VID to MSTID and GCPI assignments;

FIG. 3 illustrates a configuration of an exemplary EVA Opaque LSA in one embodiment of the present invention;

FIG. 4 illustrates an exemplary format of a MSTID assignment TLV in one embodiment of the present invention;

FIG. 5 illustrates an exemplary format of a GCPID assignment TLV in one embodiment of the present invention;

FIG. 6 illustrates an exemplary format of a VID sub-object used by both TLVs;

FIG. 7 is a flow chart illustrating the steps according to the teachings of the present invention; and

FIG. 8 illustrates an exemplary format of an alternate GCPID assignment TLV.

### DETAILED DESCRIPTION

A system and method for identifying non-Multiple Spanning Tree Protocol control planes is disclosed. The present invention utilizes a General Control Plane ID (GCPID) that identifies a specific control plane instance within the MSTID. The GCPID may be utilized in a similar fashion as a MSTID to further bind subsets of VIDs to one of the parallel new control plane instances. The present invention also utilizes a new managed object within a General Control Plane (GCP) Configuration Table that contains a mapping of VIDs to GCPIDs. Preferably, to ease management and ensure consistent configuration in each interconnected bridge, each GCP instance has a GCPID and an optional Short GCP name. In a single forwarding domain, each bridge is configured with exactly the same GCPID, short GCP name, and GCP Configuration Table. The same VIDs may be mapped to the same GCPID. Network operations and maintenance preferably checks for consistency. Thus, the present invention utilizes a new GCPID, advertises the bindings of VID GCPID/MSTID, utilizes Open Shortest Path First (OSPF) for advertisements, and two encoding type examples.

To implement the present invention, the VID to the MSTID and GCPID assignments are advertised. When setting up a spanning tree (e.g., for switch port boards (SPB)), multipoint or point-to-point connection (e.g., with GMPLS control plane for Ethernet (GELS)), it is necessary to identify which VLANs are assigned to which MSTID and GCPID.

Open Shortest Path First-Traffic Engineering (OSPF-TE) may be used to carry the VLAN configuration information. The network nodes may then determine the configuration of VID to MSTI mappings as well as the VID assignment to non-MSTP control planes and, subsequently, identify the alternative control plane instance through the GCPID. To provide for a consistent VLAN configuration, Label Edge Routers (LERs) and Label Switch Routers (LSRs) in a GMPLS context may select proper VIDs out of the set assigned under GMPLS' control. Furthermore, the OSPF flooding procedure may be used to check consistent configuration throughout the network and generate a mis-configuration error/notification to a Network Management System (NMS) for troubleshooting.

To advertise the VID/MSTID/GCPID assignment, a new Ethernet VID Assignment (EVA) Opaque Link State Advertisement (LSA) is defined. The EVA LSA is only generated if the assignments change. The EVA LSA describes the assignments utilizing two new Type-Length Values (TLVs), a MSTID assignment TLV and a GCPID assignment TLV. Each TLV corresponds to a specific MSTID or GCPID. Subsequent VID sub-objects define the associated VLAN IDs.

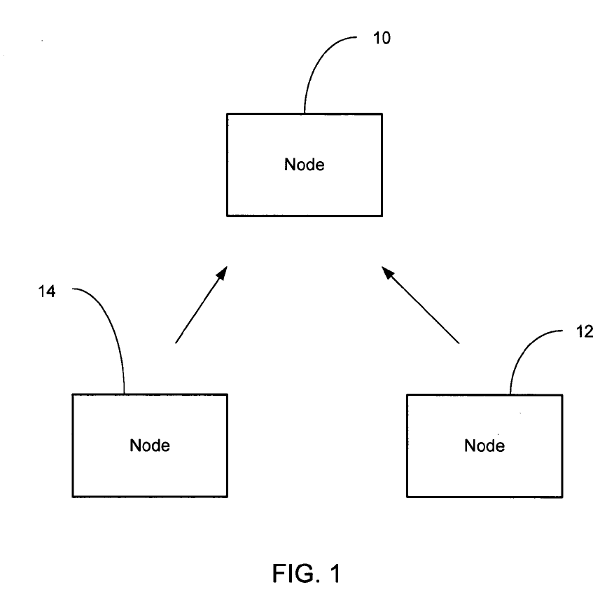

FIG. 1 illustrates a simplified block diagram of node 10 for verifying VID to MSTID and GCPID assignments in one embodiment of the present invention. Node 10, supporting the EVA LSA tracks the EVA information received from other nodes 12 and 14. The node 10 checks its local VLAN configuration against the configuration obtained from the received LSAs. If there is a mismatch in the VID to MSTID or GCPID assignment, the node 10 sets a local EVA Consistency Error Detected indication and marks each conflicting VID with a “VID Disabled” bit in the local TE database. This bit is checked before assigning a resource, e.g., with RSVP-TE, to a spanning tree or a Link Synchronization Process (LSP). Preferably, only a VID that is not in use or disabled is permitted to be assigned to a connection. Thus, affected VIDs are preferably not utilized until the inconsistency problem is resolved. Node 10 which sets the EVA Consistency Error Detected flag may also optionally send an error message to the NMS.

In addition, if the EVA Consistency Error Detected flag is set, node 10 may set the Error (E) bit in the Options field of the EVA LSA. This E bit may be used to indicate to other nodes that a mis-configuration persists. If the EVA consistency error detected flag is clear, the E bit should not be set.

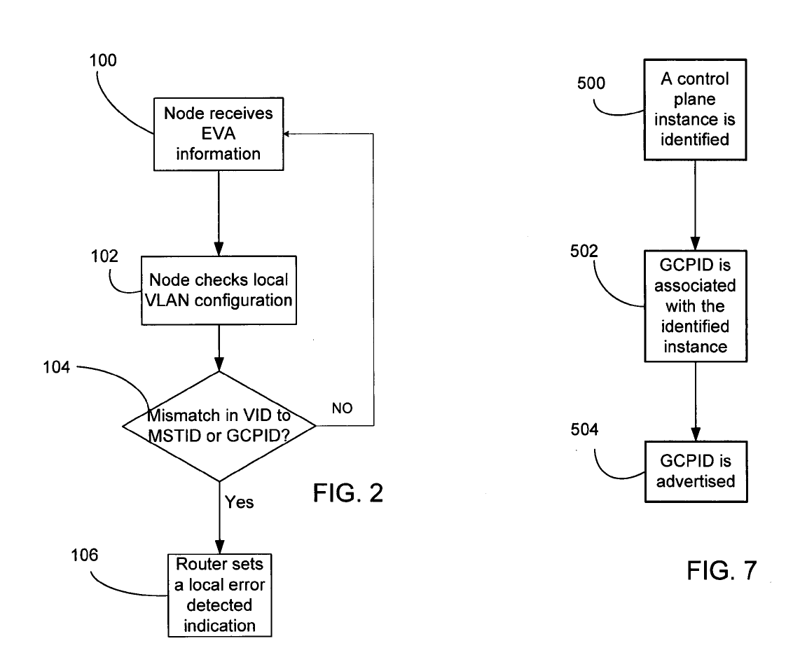

FIG. 2 is a flow chart illustrating the steps of verifying a VID to MSTID and GCPI assignments. The method begins with step 100 where node 10 supporting the EVA LSA receives EVA information from other nodes 12 and 14. Next, in step 102, node 10 checks its local VLAM configuration against the configuration obtained from the received LSAs. In step 104, it is determined if there is a mismatch in the VID to MSTID or GCPID assignment. If it is determined that there is a mismatch in the VID to MSTID or GCPID assignment, the method moves to step 106 where node 10 sets a local EVA Consistency Error Detected indication. However, in step 104, if it is determined that there is not a mismatch, the method returns to step 100 where node 10 continues to receive EVA information. It should be understood that the system and method of verifying the VID may be implemented in any fashion and still remain in the scope of the present invention.

In another embodiment, a dedicated route/resource calculation entity, such as a Path Computation Element (PCE), may conduct the verification process by comparing the received EVA LSAs to each other by crosschecking the network configuration or by comparing to a priori configuration known to the PCE.

Currently, a new Opaque LSA type, a Traffic Engineering LSA having two top level TLVs, a Router Address and a Link TLVs has been introduced. The Opaque LSA may be utilized to advertise specific TE properties of attached links, such as Link type, Link ID, Local interface IP address, Remote interface IP address, Traffic engineering metric, Maximum bandwidth, Maximum reservable bandwidth, Unreserved bandwidth, and Administrative group. In other embodiments, the TE LSA supports the carriage of link state information for GMPLS. More specifically it enhances the Link TLV with sub TLVs to advertise Link Local and Remote Identifiers, Link Protection Type, Interface Switching Capability, and Shared Risk Link Group information. In another embodiment, extensions have been proposed to OSPFv2 and OSPFv3 for advertising the capabilities of routers in a routing domain. In contrast to the TE LSA, which includes per link/interface specific description, this extension allows advertising per node/platform information. A new optional Router Information (RI) LSA is proposed for this purpose. The RI LSA will be originated initially when an OSPF router instance is created and whenever one of the advertised capabilities is configured or changed. The RI LSA payload consists of one or more nested TLVs. One TLV may then provide an indication of a Router Informational Capabilities TLV, which includes flags that specify the router capabilities for graceful restart, stub router support and TE support.

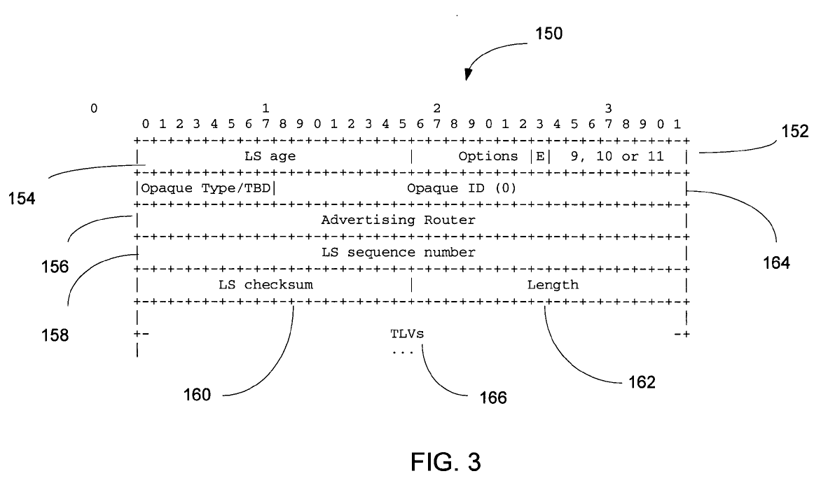

To advertise the VID/MSTID/GCPID assignment, a new Ethernet VID Assignment (EVA) Opaque LSA may be utilized. FIG. 3 illustrates a configuration of an exemplary EVA Opaque LSA 150 in one embodiment of the present invention. Preferably, this VID Assignment EVA Opaque LSA is similar to the RI LSA utilized for node/platform information. The EVA LSA preferably has a flooding type of link scoped, area-scoped, or AS-scoped. The EVA LSA needs to be generated only if changes to the VLAN assignments are made. Preferably, to reduce overhead, only the affected assignments need to be advertised. In one embodiment, one flag is defined in an Options field 152. Specifically, the E (Error) flag is defined only if the advertising router detects a mis-configuration error. The E bit is clear if no error is detected. The EVA LSA includes an LS age block 154, an advertising router identifier 156, an LS sequence number 158, an LS checksum 160, a Length block 162, an Opaque ID identifier 164, and a TLV block 166.

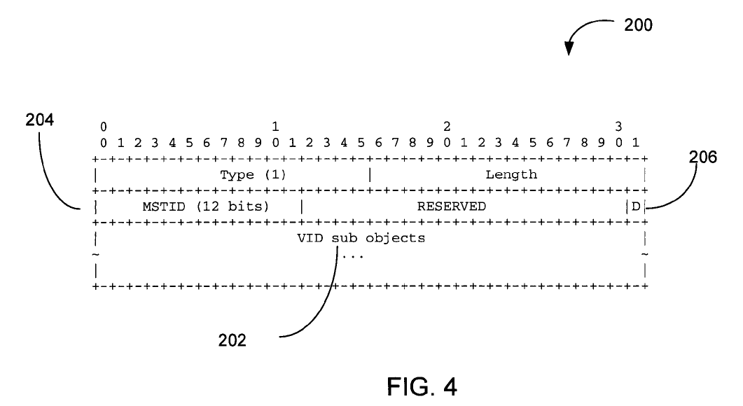

The body of the EVA LSA 150 includes a variable number of TLVs. Two TLVs include a MSTID assignment and a GCPID assignment. FIG. 4 illustrates an exemplary format of a MSTID assignment TLV 200 in one embodiment of the present invention. The MSTID assignment TLV is preferably type 1 which includes a variable number of VID sub-objects 202. If no VID sub-objects are included, then no VLANs are associated to the specified MSTID. The MSTID assignment TLV 200 includes a MSTID 204. Preferably, the MSTID is 12 bits and defines the value of the MSTID. A D bit block 206 is set if the MSTID is dedicated to non-MSTP control planes.

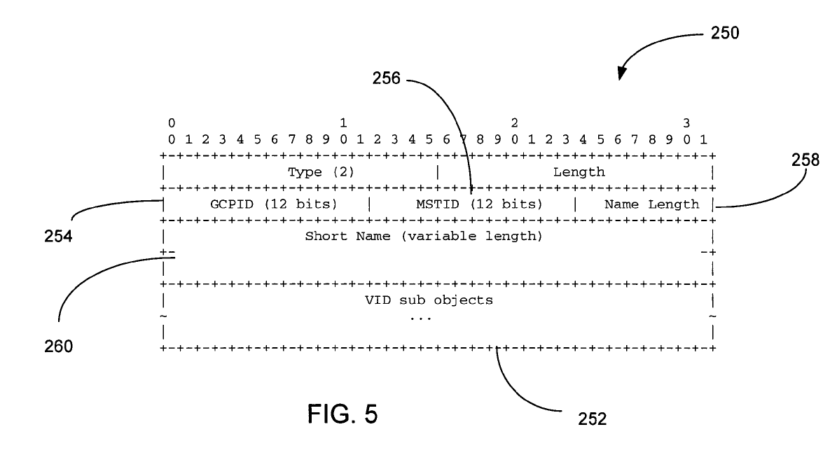

FIG. 5 illustrates an exemplary format of a GCPID assignment TLV 250 in an embodiment of the present invention. The GCPID assignment TLV is preferably type 2 which includes a variable number of VID sub-objects 252. If no VID sub-objects are included, then no VLANs are associated to the specified GCPID. The GCPID assignment TLV 250 includes a GCPID 254. Preferably, the GCPID is 12 bits and defines the value of the GCPID. An MSTID block 256, preferably 12 bits, provides the value of the MSTID to which the GCPID belongs. A name length block 258, preferably 8 bits, provides a length of the short name filed in 32 bit units and allows a maximum name length of 1024 characters. A short name block 260 is an optional filed having a null padded display string.

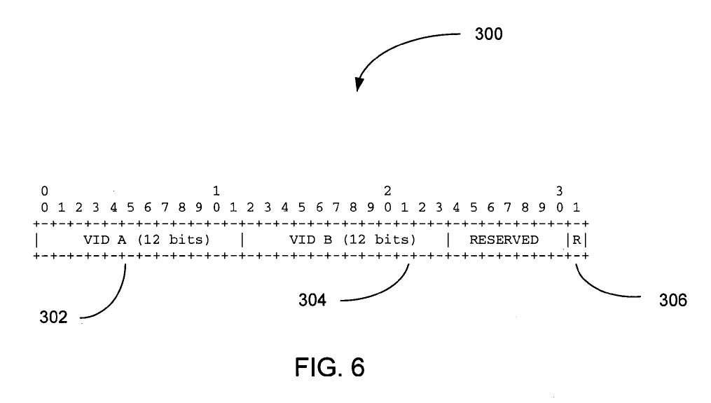

FIG. 6 illustrates an exemplary format of a VID sub-object 300 used by both TLVs. The VID sub-object includes a VID A 302 and a VID B 304, both of which are preferably 12 bits. A Range (R) bit 306 is also utilized. If the R bit is set, the VID A-VID B specifies a range of VLAM IDs that belong to the specific MSTID or GCPID. Preferably, VID A is lower than VID B. If the R bit is not set, the VID A and VID B are considered as distinct VLAN IDs.

The present invention may utilize an alternative encoding for the Ethernet VID Assignment Opaque LSA. In certain scenarios, the VIDs assigned to MSTIDs or GCPIDs are not in continuous ranges. This may lead to scalability problems with the encoding scheme used in the TLV formats discussed in FIGS. 4 and 5, which are only preferable if bulks of VIDs are assigned. In an alternate embodiment of the present invention, two new types are defined, an alternative MSTID assignment TLV with type 3 and an alternative GCPID assignment TLV with type 4. In both cases, a tree packed event list is used that allows for the compression of used bits if a bounded number of MSTID and GCPIDs are assumed.

FIG. 7 is a flow chart illustrating the steps of a method for identifying non-Multiple Spanning Tree Protocol control planes according to the teachings of the present invention. With reference to FIGS. 1-7, the method will now be explained. The method begins with step 500, where a specific non-Multiple Spanning Tree Protocol control plane instance is identified. Next, in step 502, a GCPID is associated with the specific control plane instance. The GCPID binds a VID with the specific control plane. In step 504, the GCPID is advertised, thereby identifying the specific control plane instance.

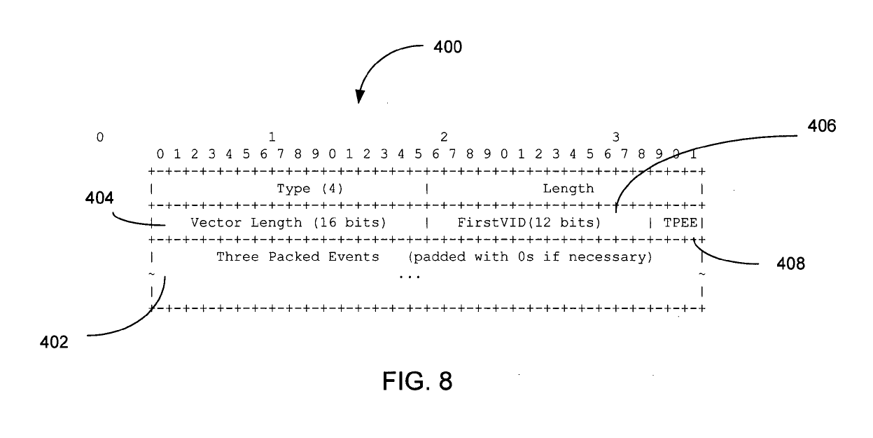

FIG. 8 is an illustration of an alternate GCPID assignment TLV 400. As illustrated in this example, six different IDs are shown. The IDs are referenced from 0 to a max ID. 0 is interpreted as belonging to a MSTP control in the case of a GCPID assignment. In the case of an MSTID assignment of a 0, the assignment refers to GCP controlled VIDs. A Three Packed Event Encoding (TPEE) field 402 allows the extension to more than six IDs. TPEE=0 refers to the below encoding of vectors. Other values may be defined for other encodings. The alternate GCPID assignment TLV 400 includes a vector length field 404, a FirstVID 406, and a TPEE field 408. The TLV 400 is preferably structured as a GCPList. In this embodiment, the GCPList consists of one or more VectorVIDs. The last element in the GCPList is an EndMark. A VectorVID preferably consists of a VectorLength, a FirstValue, and a Vector. The VectorLength may encode the number of VID to GCPID configuration entries encoded in the vector.

A formal description of the GCPList structure may include the following BNF productions:
GCPList::=VectorVID {, VectorVID}
VectorVID::=VectorLength, FirstValue, Vector
VectorLength SHORT::=NumberOfValues
FirstValue::=The first VID
Vector::=ThreePackedEvents {, ThreePackedEvents}
ThreePackedEvents BYTE::=(((((GCP)*6)+GCP)*6)+GCP)
GCP BYTE::=MSTP|GCP1|GCP2|GCP3|GCP4|GCP5
NumberOfValues SHORT::=Number of events encoded in the vector
MSTP::=0 (VIDs are under MSTP control)
GCP1::=1 (VID is under the control of GCP 1)
GCP2::=2 (VID is under the control of GCP 2)
GCP3::=3 (VID is under the control of GCP 3)
GCP4::=4 (VID is under the control of GCP 4)
GCP5::=5 (VID is under the control of GCP 5)

The parameters identified in the structure definition above may be encoded as discussed below. A GCP may be encoded as an unsigned decimal number in the range 0 through 5. The permitted values and meanings of the GCP may be as follows:
0: Specifies MSPT
1: GCPID1
2: GCPID2
3: GCPID3
4: GCPID4
5: GCPID5

The FirstValue field may be encoded as two octets, taken to represent an unsigned binary number, and equal to the value of the VLAN identifier that is to be encoded.

The VectorLength is used to encode the NumberOfValues. The range of values that NumberOfValues may be restricted. For example, the size of the Vector that is defined by this number may fit in the available space in the PDU. The number of GCPID values, added to the number encoded in FirstValue preferably does not exceed 4094. The number of GCP values is non-zero, and preferably does not exceed 4094. In addition, the VectorLength field is preferably 2 bytes long.

The Vector may be encoded as one or more 8-bit values. Each 8-bit value may contain a numeric value, ThreePackedEvents, derived from three packed numeric values, each of which represents a GCP, in the range 0 though 5. Each 8-bit value may be derived by successively adding an event value and multiplying the result by 6. To facilitate the subsequent description, the event values are numbered from first to third, as follows:

ThreePackedEvents BYTE::=(((((firstGCP)*6)+secondGCP)*6)+thirdGCP)

The VectorLength of the VectorVID may determine the number of 8-bit

ThreePackedEvents values, E, that may be present in the vector. Thus, E may be determined by dividing NumberOfValues by 3 and rounding any non-integer answer up to the nearest larger integer.

The FirstValue field of the VectorVID may determine which of the originator's GCP configuration table entry the first GCPID value in the first ThreePackedEvents value relates to. The second GCPID value in the first ThreePackedEvents value corresponds to the GCP configuration table entry identified by (FirstValue+1), and the third AttributeEvent value in the first ThreePackedEvents value corresponds to the entry identified by (FirstValue+2), through subsequent packed values. If the NumberOfValues field carries a value that is not a multiple of 3, one or two GCPID values packed in the final ThreePackedEvents may be ignored. These values are then encoded as the numeric value 0 on transmission and are ignored on receipt.

In another embodiment to signal the VID/MSTI/GCPID assignment, two new sub TLVs are added to the RI LSA. Specifically, an Ethernet VID Assignment MSTI sub TLV and an Ethernet VID Assignment GCPID sub TLV may be added. Multiple EVA MSTI and EVA GCPID sub TLVs may be carried within the same RI LSA. The format and structure of these TLVs are the same as the TLVs discussed above with the exception that the TLV type are harmonized with the types used within the scope of the RI LSA.

The present invention provides solution to differentiate multiple non-MSTP control planes running over a single MSTID. The present invention may be implemented in systems utilized standards promulgated by IEEE and IETF.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method of identifying non-Multiple Spanning Tree Protocol control planes, the method comprising the steps of:
identifying a specific non-Multiple Spanning Tree Protocol control plane instance;
associating a General Control Plane Identification (GCPID) with the specific control plane instance, wherein the GCPID binds one or more Virtual Local Area Identifier (VID) with the specific control plane; and
advertising the GCPID to identify the specific control plane instance.

2. The method as recited in claim 1 wherein the step of associating a GCPID with the specific control plane includes implementing a new managed object within a General Control Plane Configuration Table containing a mapping of a plurality of VIDs to a plurality of GCPIDs.

3. The method as recited in claim 2, wherein each control instance includes a GCPID and a General Control Plane name.

4. The method as recited in claim 1, wherein the step of advertising the GCPID includes utilizing a routing protocol for advertising the GCPID.

5. The method as recited in claim 4, wherein the step of advertising the GCPID utilizes the routing protocol Open Shortest Path First (OSPF) and includes defining an Ethernet VID Assignment (EVA) Opaque Link State Advertisement (LSA).

6. The method as recited in claim 5, wherein the EVA LSA utilizes a MSTID a Type-Length Value (TLV) corresponding to a specific Multiple Spanning Tree Identifier (MSTID) and a GCPID assignment TLV corresponding to a specific GCPID.

7. The method as recited in claim 6, wherein the LSA is a route information LSA and utilizes a sub TLV Spanning Tree Instance assignment and a sub GCPID assignment harmonized with the route information LSA.

8. The method as recited in claim 6, further comprising the step of determining a configuration of the VID to Spanning Tree Instance mappings and a VID assignment to non-Multiple Spanning Tree Protocol control planes.

9. The method as recited in claim 6, further comprising the steps of:
verifying a consistent configuration of a VID assignment to MSTID and GCPID of a control plane; and
upon determining an inconsistent configuration during the step of verifying a consistent configuration, generating a notification of an inconsistent configuration.

10. A system for identifying non-Multiple Spanning Tree Protocol control planes, the system comprising:
a network node having:
means for identifying a specific non-Multiple Spanning Tree Protocol control plane instance;
means for associating a General Control Plane Identification (GCPID) with the specific control plane instance, wherein the GCPID binds a Virtual Local Area Network Identifier (VID) with the specific control plane; and
means for advertising the GCPID to identify the specific control plane instance.

11. The system as recited in claim 10, wherein the means for associating a GCPID with the specific control plane includes means for implementing a new managed object within a General Control Plane Configuration Table containing a mapping of a plurality of VIDs to a plurality of GCPIDs.

12. The system as recited in claim 10, wherein each control instance includes a GCPID and a General Control Plane name.

13. The system as recited in claim 10, wherein the means for advertising the GCPID includes utilizing Open Shortest Path First (OSPF) for advertising the GCPID.

14. The system as recited in claim 13, wherein the means for advertising the GCPID includes means for defining an Ethernet VID Assignment, (EVA) Opaque Link State Advertisement (LSA).

15. The system as recited in claim 14, wherein the EVA LSA utilizes a MSTID having a Type-Length Value (TLV) corresponding to a specific Multiple Spanning Tree Identifier (MSTID) and a GCPID assignment TLV corresponding to a specific GCPID.

16. The system as recited in claim 15, wherein the LSA is a route information LSA and utilizes a sub TLV Spanning Tree Instance assignment and a sub GCPID assignment harmonized with the route information LSA.

17. The system as recited in claim 15, further comprising means for determining a configuration of the VID to Spanning Tree Instance mappings and a VID assignment to non-Multiple Spanning Tree Protocol control planes.

18. The system as recited in claim 15, further comprising:
means for verifying a consistent configuration of a VID assignment to MSTID and GCPID of a control plane; and
responsive to means for verifying a consistent configuration determining an inconsistent configuration, generating a notification of an inconsistent configuration.

19. A node for identifying non-Multiple Spanning Tree Protocol control planes, the node comprising:
means for identifying a specific non-Multiple Spanning Tree Protocol control plane instance;
means for associating a General Control Plane ID (GCPID) with the specific control plane instance, wherein the GCPID binds a Virtual Local Area Network Identifier (VID) with the specific control plane; and
means for advertising the GCPID to identify the specific control plane instance.

20. The node as recited in claim 19, wherein the means for associating a GCPID with the specific control plane includes means for implementing a new managed object within a General Control Plane Configuration Table containing a mapping of a plurality of VIDs to a plurality of GCPIDs.

21. The node as recited in claim 19, wherein each control instance includes a GCPID and a General Control Plane name.

22. The node as recited in claim 19, wherein the means for advertising the GCPID includes utilizing Open Shortest Path First (OSPF) for advertising the GCPID.

23. The node as recited in claim 22, wherein the means for advertising the GCPID includes means for defining a Ethernet VID Assignment, (EVA) Opaque Link State Advertisement (LSA).

24. The node as recited in claim 23, wherein the EVA LSA utilizes a MSTID having a Type-Length Value (TLV) corresponding to a specific Multiple Spanning Tree Identifier (MSTID) and a GCPID assignment TLV corresponding to a specific GCPID.

25. The node as recited in claim 24, wherein the LSA is a route information LSA and utilizes a sub TLV Spanning Tree Instance assignment and a sub GCPID assignment harmonized with the route information LSA.

26. The node as recited in claim 24, further comprising means for determining a configuration of the VID to Spanning Tree Instance mappings and a VID assignment to non-Multiple Spanning Tree Protocol control planes.

27. The node as recited in claim 24, further comprising:
means for verifying a consistent configuration of a VID assignment to MSTID and GCPID of a control plane; and
responsive to means for verifying a consistent configuration determining an inconsistent configuration, generating a notification of an inconsistent configuration.
